(19) United States
(12) Patent Application Publication
(10) Pub. No.: US 2010/0236210 A1
(43) Pub. Date: Sep. 23, 2010

(54) Shovel -O-Mate

(76) Inventor: Omar Compton, Detroit, MI (US)

Correspondence Address: Mr. Omar J. Compton, 17361 Cherrylawn, Detroit, MI, 48221, US

(21) Appl. No.: 12/383,274

(22) Filed: Mar. 23, 2009

(51) Int. Cl. A01D 7/00

(52) U.S. Cl. 56/400.11

(57) ABSTRACT

A shovel with a short tubular metal shaft, affixed with a hollow cylinder in a horizontal position at the top, of a downward angled shaft, with the shovel blade parallel to the ground. A rake handle shaft is inserted through the cylinder with the fangs of the rake are directly and slightly over the shovel blade.

### RELATED APPLICATIONS

U.S. Patent Documents

| | | | |
|---|---|---|---|
| 125,480 | April, 1872 | Newnan. | 56/400. |
| 1,277,998 | September, 1918 | Niemoth. | 56/400. |
| 2,504,943 | April, 1950 | Zifferer | 56/400. |
| 2,908,131 | October, 1959 | Ross | 56/400. |
| 3,350,886 | November, 1967 | Spencer | 56/400. |
| 3,688,484 | September, 1972 | Cox | 56/400. |
| 4,037,394 | July, 1977 | Fiorentino | 56/400. |
| 4,057,277 | November, 1977 | Burkholder | 56/400. |
| 4,378,671 | April, 1983 | Gascon | 56/400. |
| 4,427,227 | January, 1984 | Haskell | 294/50. |
| 4,741,149 | May, 1988 | vom Braucke et al. | 56/400. |
| 4,791,780 | December, 1988 | Phillips | 56/400. |
| 4,991,386 | February, 1991 | Dirksen | 56/400. |
| 5,144,199 | May, 1992 | Newcomer | 294/50. |
| 2,504,943 | April, 1950 | Zifferer | 56/400. |
| 3,601,966 | August, 1971 | Kerry | 56/400. |
| 4,018,038 | April, 1977 | Sipe | 56/400. |
| 4,292,794 | October, 1981 | Gascon | 56/400. |
| 4,378,671 | April, 1983 | Gascon | 56/400. |
| 5,303,536 | April, 1994 | Tolliver | 56/400. |
| 5,765,351 | June, 1998 | Frankhouser | 56/400. |
| 5,901,540 | May, 1999 | Vella | 56/400. |

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

The present invention relates to a shovel implement, for joining with a rake for sifting/combing leaves/debris from a grassy lawn, more particularly to a pick-up rake and shovel combination that enables a user to grab leaves and other debris with the rake, thereby facilitating their disposal.

### DESCRIPTION OF PRIOR ART

The use of rake combination is known in the prior art, More specifically, shovel and rake combinations for the purpose of accomplishing yard work are known to consist technically familiar configurations and a large myriad of designs.

The following art defines the present state of this field:

While Kerry and Gascon suggest a double-hinge similar to the present invention, they do not teach a slider element, a slider rod, and first and second slider hinge elements that enable the slider element to operably control the movement of the grasping element without interfering with the folding of the connector element.

Gascon, U.S. Pat. No. 4,378,671, teaches a pick-up rake having a main rake head and an auxiliary rake head movably mounted with respect to the main rake head, enabling the auxiliary rake head to be moved from a storage position adjacent to the main rake head to a position where the two rake heads cooperatively act to grasp leaves and grass therebetween. When the auxiliary rake head is in storage position, the rake may simply be used in a conventional manner for the raking of leaves and grass; while in pick-up configuration, the rake enables grass and leaves to be picked up avoiding the necessity of one having to stoop or kneel to gather leaves or grass for disposal.

Gascon, U.S. Pat. No. 4,292,794, teaches a pick-up rake having a main rake head and an auxiliary rake head movably mounted with respect to the main rake head enabling the auxiliary rake head to be moved to an upper laterally-compacted position enabling the rake to be used in conventional fashion and movable to a lowered laterally-expanded position where the two rake heads cooperatively act to grasp leaves and grass and the like.

Frankhouser, U.S. Pat. No. 5,765,351, teaches a garden rake pick-up attachment for a garden rake of the type having a bow rake head tine section and a handle comprises a pick-up tine section, a clamp section, and a handle section: the pick-up tine section comprising a tine bar carried by yoke bars, the yoke bars having a yoke section therein including a hinge member extending between the yoke bars. the clamp section comprises top and bottom clamps shaped to engage the garden rake yoke bars and to confine the hinge member relative to the garden rake tine section. The pick-up yoke section is shaped to enable the garden rake handle to pass therethrough. The pick-up handle section comprises an elongated handle rod pivotably connected to the pick-up yoke section, a handle grip at an opposite end of the handle rod, and a stop for holding the pick-up tine section in an open position. The pick-up handle section is configured to provide a limit stop to prevent the pick-up tine section from being closed beyond a predetermined limit when installed on the garden rake.

Laughlin, U.S. Pat. No. 5,564,266, teaches grass rake tongs consisting of a pair of rakes each having an array of tines joined to a handle by a ferrule and means such as a pin or bolt disposed through the handles above the ferrules at a point approximately midway between the lower end of the tines and the upper end of the handles pivotally connection the handles for rotation with inside portions of said arrays of tines opposing each other. Preferably, rotation about the pivot extends approximately 180.degree. from a fully opened condition in which the handle of each rake abuts an outer portion of the array of tines of the other rake to a fully closed condition in which an inner surface of each array of tines abuts an inner surface of the other array of tines.

vom Braucke et al., U.S. Pat. No. 4,741,149, teaches a garden-clearing tool that includes a rake and a pivotally mounted grasping element that can be used to clamp debris under the motivation of a slider assembly similar to the present invention (see FIG. 3). However, this tool does not teach the use of a connector element having first and second rake hinge elements that enable the proper folding of the grasping element. This tool will not function unless the tool is held perpendicular to the ground, otherwise the grasping element cannot be closed. Only the “double hinge” structure of the present invention allows this flexibility.

Kerry, U.S. Pat. No. 3,601,966, teaches a combination rake and pickup device consisting of a pair of oppositely disposed conventional broom rake heads, one of which has attached thereto an elongated handle. The other rake head is movably supported by the elongated handle, and may be selectively shifted to either an inoperative retracted position, or an advanced position where it enters into a holding relationship with the first mentioned rake head.

Kalavitis, U.S. Pat. No. 6,151,878, teaches a rake having a supplemental rake pivotally attached for picking up leaves. In one embodiment (FIGS. 8-9), the supplemental rake is pivotally attached with a double hinge. Significantly, however, the extension arm is pivotally attached to the double hinge, not to the supplemental rake (grasping element). While this design is close to the present invention, the critical change in the attachment of the slider rod leads to a significant change in the folding of the mechanism and function of the rake.

Sample, U.S. Pat. No. 4,730,864, teaches a trash and leaf gathering and pick up tool having two rake like gathering heads pivotally interconnected to close and open toward and away from each other in a jaw like action. One of the rake like gathering heads has a handle adapted to fit a user's arm and is equipped with an arm band for mounting of the tool on an arm. The other rake like gathering head has a handle extending through the pivot interconnect with the handle mountable on an arm to a hand grip equipped end positioned for being grasped by the hand of the arm mounting the tool whereby the tool is manually manipulated in its closing leaf and trash grasping action and jaw opening manipulation to dump trash.

Nelson, U.S. Pat. No. 4,545,189, teaches an attachment to a conventional rake having a grasping head pivotally attached to a link which is pivotally attached to the rake head such that an operable clamp is formed, the grasping head being operated by a lever attached to the rake's handle. The pivotal link separates the upper portions of the two heads such that the capacity of the “grasp” is greater than that of conventional rakes with grasping apparatus.

Blanco, U.S. Pat. No. 4,185,448, teaches a rake of the type having a fanned spring finger main raking head fixed at one end of a rake handle provided with an auxiliary, complementary fanned spring finger rake head pivotally supported with respect to the rake handle and movable into clamping jaw-like relation with respect to the main raking head for picking up raked trash piles. The individual spring fingers of one rake head are receivable between the spring fingers of the other rake head to provide for raking with either rake head when they are held in relatively clamped together position.

Wetherall et al., U.S. Pat. No. 4,143,899, teaches an implement for gathering objects lying on the ground having an elongate handle. A transverse member is mounted at a forward end of the handle. This member has a rearward surface extending at an oblique angle to the axis of the handle. A movable member is pivotally mounted at or adjacent the forward-end of the handle for movement between an inactive position and an active position. In the active position it cooperates with the rearward surface of the transverse member for picking up objects from the ground. The movable member is biased towards its inactive position by spring means.

Sipe, U.S. Pat. No. 4,018,038, teaches a hand rake with grasping tines disclosed including a pair of multitined fork members, a frame assembly for pivotally holding the fork members in spaced facing relation, a handle assembly secured to the frame assembly for carrying the fork members, and a control mechanism for cooperatively varying the pivotal dispositions of the fork members from an open material raking condition to a closed material transporting condition.

Osadsky, U.S. Pat. No. 3,733,636, teaches a combination implement including a broom, a shovel mounted on one side of said broom adapted to be shifted from a raised, inoperative position to a lowered, operative position projecting below the broom head, and a scraper mounted on the opposite side of said broom adapted to be shifted from a raised position to a lowered position projecting below said broom, said shovel and scraper forming rigid elements when in their raised, inoperative positions preventing the broom bristles from bending too far and breaking during use, thereby promoting the useful life of said broom.

A. L. Jackson, U.S. Pat. No. 3,264,809, teaches the movement of objects of various kinds together in order that they may be collected and removed in a group and also relates to apparatus and equipment by which such collection and removal can be accomplished.

P. S. Vosbikian et al., U.S. Pat. No. 3,105,348, teaches a novel construction and arrangement of a garden rake and more particularly a novel means to clamp the material, which has been raked up against the teeth of the rake.

T. A. Pasquine, U.S. Pat. No. 3,095,682, teaches a leaf rake and the like and more particularly a rake incorporating a second rake assembly so arranged to be used in connection with the principal rake assembly in carrying material such as leaves and grass.

A. B. Utley, U.S. Pat. No. 2,746,234, teaches a garden rake and has special reference to a garden rake provided with a trash gripping device.

M. F. Zifferer, U.S. Pat. No. 2,504,943, teaches a rake of the broom type in which is incorporated means whereby it may serve to pick up a quantity of leaves or rakings facilitate transportation thereof from one place to another. For this purpose the rake is provided with a fixed head forming a mounting for one set of aligned tines, and with a second head, swingingly mounted with respect to the first, forming a mounting for a second set of aligned tines which are adapted to interfit with those of the first set whereby all the tines of both sets may occupy operative positions in alignment.

E. P. McFadden, U.S. Pat. No. 1,715,613, teaches garden rakes, the primary object of the invention being to provide a rake of this character equipped with a device for gathering and holding trash, grass and the like and carrying it to any desired dumping place where it may be released.

D. W. Frank, U.S. Pat. No. 1,424,291, teaches a new and useful implement from the combination of various other implements into a unified structure, so that the user may more conveniently and efficiently avail himself of the separate or joint use of any of the implements so combined.

J. Peacock, U.S. Pat. No. 1,050,685, teaches a combined garden tool wherein will be embodied a rake, a sod trimmer and a hoe which are so arranged relatively to the handle that either one may be conveniently exposed for use.

R. D. Ake, U.S. Pat. No. 603,071, teaches a combined brush and dust scoop or shovel especially designed for use for street-cleaning purposes and to save time in its use and expense in its manufacture as compared with the use of separate implements heretofore employed for the purpose.

E. Starkwether, U.S. Pat. No. 599,368, teaches a lawn-rake, a scraper, a hoe, a weed-cutter, and a window cleaner combined.

Tolliver, U.S. Pat. No. 5,303,536, teaches a lawn rake with debris pickup capability. The lawn rake is particularly useful as an implement for raking leaves, debris from a grassy lawn into piles, then to encircle/grasp the debris pile for lifting, transport and dumping. In using the Lawn rake, the operator does not have to bend over to pick up leaf/debris piles.

Segla, U.S. Pat. No. 5,513,883, teaches an implement for receiving and containing ashes during cleaning of a stove or fireplace. The inventive device includes a collection box for scooping and receiving ashes. A closure is pivotally mounted to the box for containing the ashes therewithin. A handle assembly extends from the box for facilitating manual manipulation of the box and operation of the closure.

Matthews et al., U.S. Pat. No. 4,930,824, teaches a gutter cleaner for remotely cleaning an overhead gutter of the like which includes an elongate handle, a pair of cooperating fork-like jaws mounted at the upper end of the handle, and a sleeve slidably mounted on the lower end of the handle for selectively opening and closing the fork-like jaws. The jaws include a stationary first jaw and a pivotably movable second jaw which each have a greater width than height so that the jaws may be placed in a gutter extending in a direction lengthwise with the gutter. In this manner a substantial length of the gutter may be cleaned of collected debris with each application of the gutter cleaner thereto.

Russell, U.S. Pat. No. 5,058,370, teaches a pick-up head hingedly attached to the rear side of a lawn rake making lawn work easier and more convenient. The arm attached to the pick-up head is pushed into a clamp on the rear side of the rake handle. This clamp holds the pick-up head assembly secure in an upright, storage position while allowing normal raking. When pick-up is desire, the arm is pulled forward releasing it from the clamp and manually pushes the pick-up head into position adjacent the main rake head thus compressing debris between the two heads. The debris may be released by returning the assembly back into the original upright position.

Cohen, U.S. Pat. No. Des. 296,510, teaches an ornamental design for a combined rake and collector.

Billstam et al., WO 94/07353, teaches a rake assembly comprising a handle and a rake-unit which coacts with one end-part of the handle, wherein the rake-unit comprises a single rake-part or two rake-parts, and wherein the rake-part or rake-parts is/are attached to the end-part of the handle by means of a respective pivot shaft such as to enable the rake-unit part or rake-unit parts to be moved to a position transversely to the handle and a position parallel with said handle. The rake assembly is characterized in that the single rake-unit part or the two rake-unit parts is/are pivotally mounted to the end-part of the handle in a manner to provide an opening into which an additional tool, such as a ball retriever, can be firmly but removably fitted.

Bietrix, WO 00/57687, teaches a novel gardening tool similar to a rake or broom for the garden comprising fixed teeth and moveable teeth, characterized in that it comprises a handle that slides on a stick which pushes a rod that is fixed on a transverse member that actuates said movable teeth between a closed position and an open position and in that the fixed teeth and the moveable teeth are disposed on the same plane when in a closed position.

Darnell, WO 95/31890, teaches a foldable rake implement including an elongated handle having a proximal end to be grasped by the user and a distal end. An articulated frame structure is attached to the handle at the distal end. The articulated frame structure includes a central axis or articulation dividing the frame structure into two mirror-image first and second frame halves. The axis of articulation is coaxial with the handle and defines an axis about which the articulated frame structure moves between an unfolded position whereat the first and second frame halves of the frame structure symmetrically project outwardly to opposite lateral sides of the handle and a folded position whereat the first and second frame halves are moved toward each other and into generally mutual overlaying relationship.

### SUMMARY OF THE INVENTION

The shovel and rake combination according to the present invention substantially departs from the conventional concepts and designs of the prior art, and in so doing provides an apparatus primarily developed for the purpose of picking up leaves and debris. A device that is a stand lone shovel apparatus which can be easily slipped on and off a stand alone independent rake for the purpose of picking up leaves and debris.

Therefore, it can be appreciated that there exists a continuing need for a new and improved shovel combination that can be easily sipped on and off a rake for the primarily purpose of providing of picking up leaves and debris; this device may be utilized as attachment for a rake. In this regard, the present invention substantially fulfils this need.

In view of the foregoing disadvantages inherent in the known types of rake combinations now present in the prior art, the present invention provides an improved rake and shovel combination. As such, the general purpose of the improved invention, which will be described subsequently in greater detail, is to provide a new and improved rake and shovel combination, which has all the advantages of the prior art and none of the disadvantages.

To attain this, the present invention essentially comprises an elongated cylinder affixed to the top end of a cylindrical shovel shaft handle. The shovel shaft handle traverses an obtuse 60 degree angle downward to the lower end were the shaft is bent parallel to the ground, here the shovel blade is mounted.

The shovel handle is affixed to the cylinder, here the handle of the rake is slipped through. For movement of both rake and shovel is controlled by hand and force of gravity. The shovel movement is forward and backward and in a 360 degree rotation on the axis of rake handle shaft, The rake movement is forward and backward also can rotate 360 degree.

For dislodging the shovel from rake. Raise the rake so the head fangs portion of the rake is at a 90 degree angle from the ground. In this position the rake will dislodge the shovel apparatus.

The present invention is directed to a adaptive combination tool generally used for raking and picking up debris. The tool includes a cylinder affixed to angled shaft with a shovel blade at one end. The rake handle or shaft is inserted through the cylinder with the flanged portion of the rake extending outward past the shovel blade. The fanged portion grasping leaves or other debris between the shovel blade and the back of the rake head.

To pick up a pile of leaves the shovel blade is turned 180 degrees as to rest on top of the rake fanged portion. The fanged portion of the rack in extended over the pile of leaves, as the leaves are pulled toward the operator, simultaneously the shovel blade is turned in a 180 degree arc to a position directly under the pulling path of the rack fangs trapping a large amount of leaves. To release the leaves into a can or bag, turn the shovel and rake over the container and slowly move the rake fangs forward slightly and the leaves will fall out into the container.

Advantages of the present invention will become apparent during the following description of the presently preferred embodiment of the invention taken in conjunction with the drawings.

### BRIEF DESCRIPTION OF SEVERAL VIEWS OF THE DRAWINGS

FIG. 1 is a posterior frontal view of the Shovel-O-Mate, in accordance with one aspect of the present invention in acclimatized condition before attachment to a rake.

FIG. 2 is a posterior frontal view of the Shovel-O-Mate, in accordance with one aspect of the present invention as attached to a rake.

FIG. 3 is a side view of the Shovel-O-Mate, in accordance with one aspect of the present invention in acclimatize condition before attachment to a rake.

FIG. 4 is a side view of the Shovel-O-Mate, in accordance with one aspect of the present invention as attached to a rake.

FIG. 5 is a enlarged view of the cylinder a with hand grip affixed to the Shovel-O-Mate handle shaft of FIGS. 1-4; and

FIG. 6 is a enlarged view of the cylinder affixed to the shovel handle shaft and rake shaft handle of FIGS. 1-5.

### DETAILED DESCRIPTION OF THE INVENTION

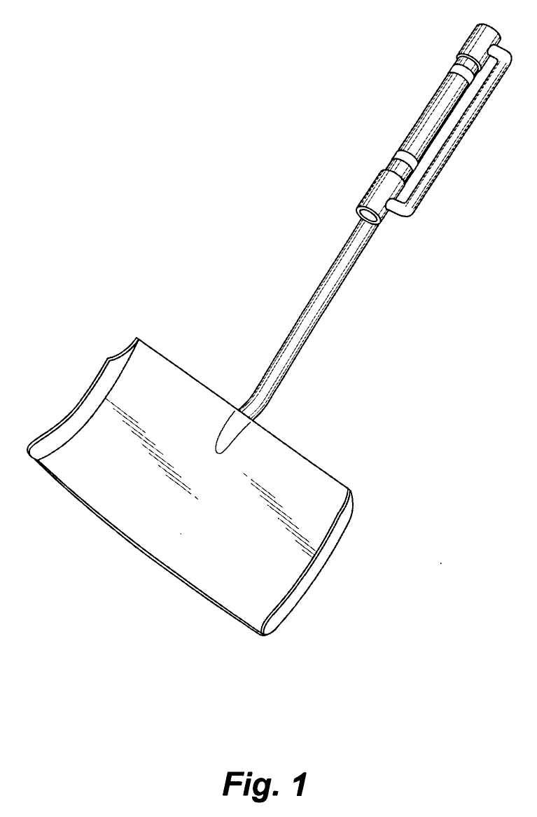

Referring to the drawings, the Shovel-O-Mate tool of the invention shown in FIG. 1. The tool includes a strong light weight aluminum first shaft with a scoop shovel blade at its distal end. The scoop shovel blade of the presently preferred embodiment is a shovel.

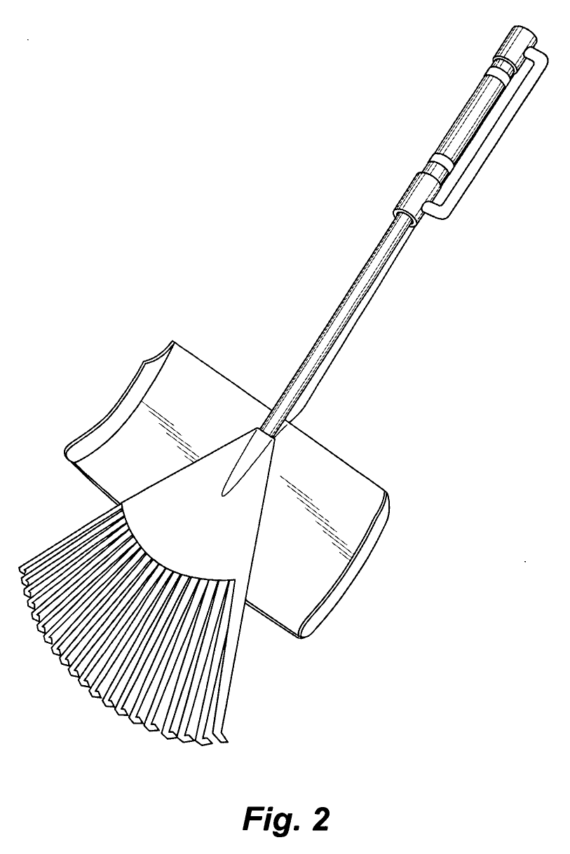

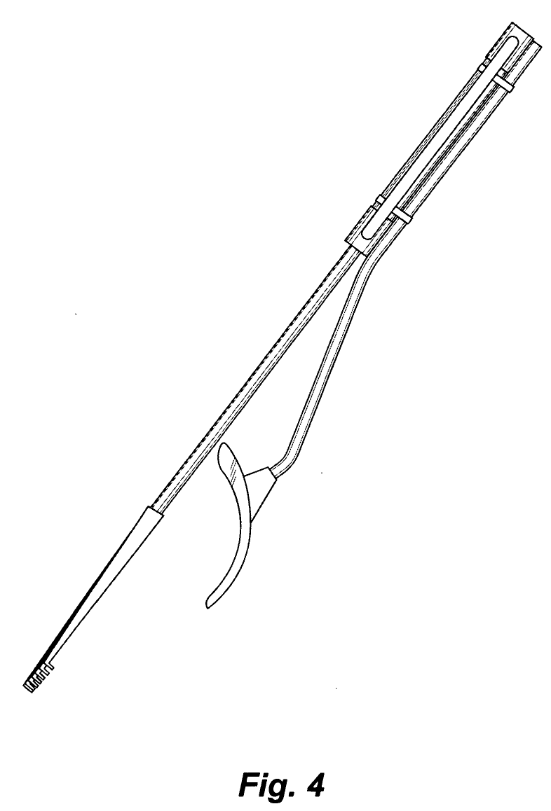

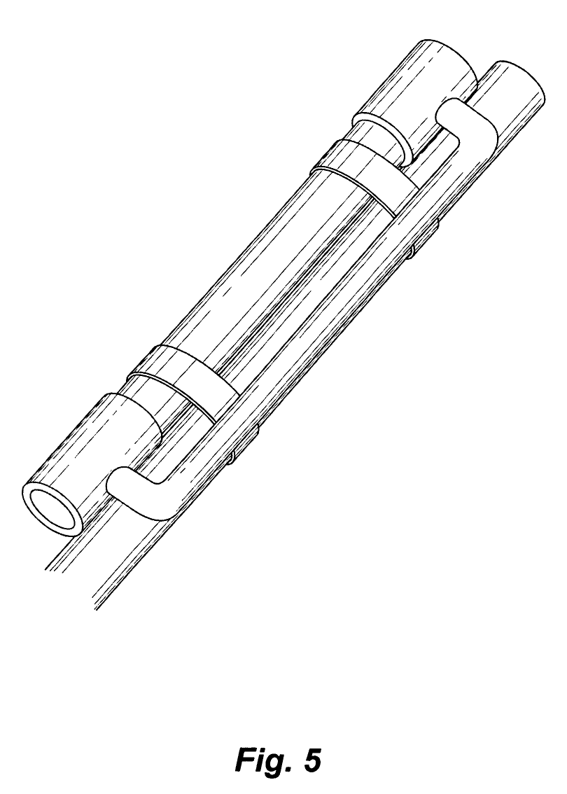

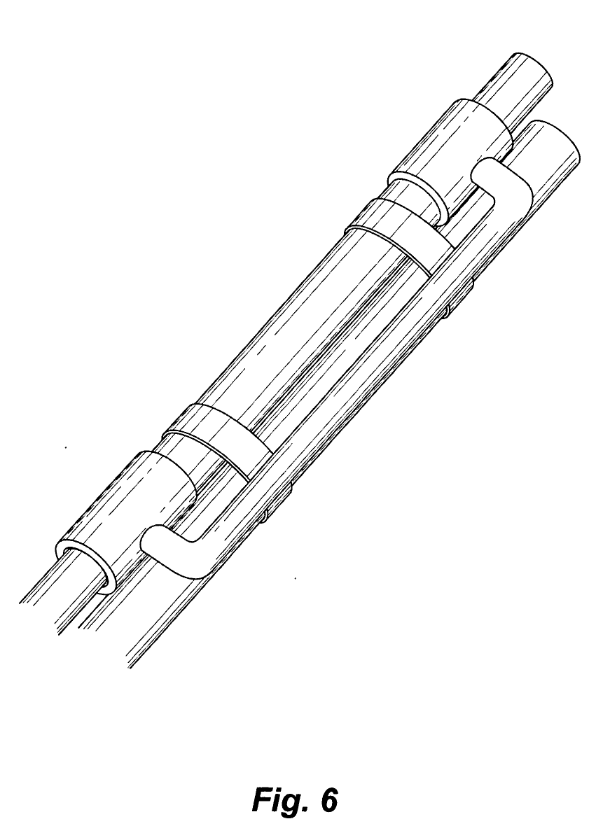

At the proximal end of the first shaft is a is hollow cylinder made from a light weight durable material such as PVC affixed with adhesives and mechanical braces to the aluminum shovel shaft as shown in FIGS. 1-6. Attacheded to the PVC cylinder is a handle also made of PVC pile extentions as shown in FIGS. 1.-6. The handle fit sightly on each end of the cylinder. In FIG. 5 is a close up view of the PVC attachments presently preferred embodiment is a affixed PVC pile cylinder with handle.

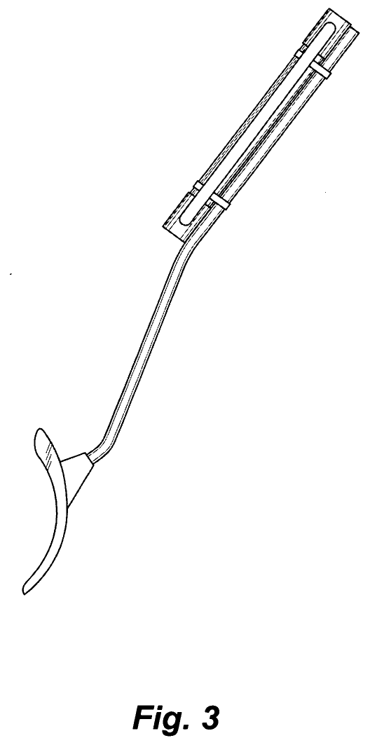

The shovel shaft is bent projecting downwards approximently 35 degree angle and bent up ward approximently 35 degree angle at the shovel blade at its distal end, shown FIG. 3 The affixed cylinder

I claim:

1. A adaptive shovel apparatus, including:
a hollow cylinder affixed and connected to an upper end of a downward angled shovel handle shaft with the shovel blade mounted to the lower end of the shaft parallel to the ground thereof;
a rake including a handle/shaft with a leaf rake head on the lower end thereof,
said rake handle shaft inserted through said cylinder for movement, wherein, controlled by hand and force of gravity in a forward backward direction and a 360 degree rotation within interior parameter of said cylinder thereof,
wherein the shovel handle apparatus is connected to the said cylinder being operatively connected to said rake for movement thereof, said shovel pivotally is controlled by hand and force of gravity Forward and backward direction and a 360 degree rotation on the axis of said rake handle shaft thereof,
wherein dislodging said shovel from said rake thereof employed the designate elements of gravity, wherein raise position of said rake whereas the head fan portion of said rake is at a 90 degree angle from the ground thereof, the displacement position of said rake angle thereto dislodging said shovel thereof.

2. The apparatus of claim 1, in which said affixed cylinder to the upper end of a downward angled of said shovel handle includes handgrip and handle for alternatively position and pivotally.

3. The apparatus of claim 2, in which said shovel with affixed said cylinder rotates around the handle shaft axis of said rake, wherein no mechanism is for selectively pivoting control between said rake and said shovel thereof, wherein said cylinder provide movement containment and downward angled shovel handle shaft provide guide orientation of said rake direction whereas the prongs of rake extend past a front edged of the shovel.
